(19) United States
(12) Patent Application Publication
(10) Pub. No.: US 2016/0156737 A1
(43) Pub. Date: Jun. 2, 2016

(54) DYNAMIC INTEREST FORWARDING MECHANISM FOR INFORMATION CENTRIC NETWORKING

(71) Applicants: Diego PERINO, Boulogne-Billancourt (FR); Giovanna CAROFIGLIO, Boulogne-Billancourt (FR); Dario ROSSI, Boulogne-Billancourt (FR); Giuseppe ROSSINI, Boulogne-Billancourt (FR)

(72) Inventors: Diego PERINO, Boulogne-Billancourt (FR); Giovanna CAROFIGLIO, Boulogne-Billancourt (FR); Dario ROSSI, Boulogne-Billancourt (FR); Giuseppe ROSSINI, Boulogne-Billancourt (FR)

(21) Appl. No.: 15/015,977

(22) Filed: Feb. 4, 2016

Related U.S. Application Data
(63) Continuation of application No. PCT/EP2014/066752, filed on Aug. 4, 2014.

(30) Foreign Application Priority Data
Aug. 5, 2013 (EP) 13306124.2

(51) Int. Cl. H04L 29/08; H04L 12/741; H04L 12/727

(52) U.S. Cl. CPC H04L 67/327; H04L 45/121; H04L 45/54; H04L 67/2842

(57) ABSTRACT

A method for managing packets over interfaces of a Content Centric Networking node, the method comprising the following steps
receiving over an interface of the node at least a request for a data packet;
if the data packet is stored by the node, forwarding the data packet over the interface of the received request;
otherwise
performing an exploration step, by
selecting randomly at least an interface towards a neighboring node;
forwarding the request over the selected interface;
receiving in response over the randomly selected interface, the data packet with associated minimum time delivery value estimated by the neighboring node;
   identifying an interface providing the minimum data packet delivery time value based on exploration step results.

### FIELD OF THE INVENTION

The present invention relates to the technical field of Content Centric Networking (CCN), and particularly to mechanisms to realize dynamic request forwarding in CCN nodes.

### BACKGROUND OF THE INVENTION

Information Centric Networking (ICN), Content Centric Networking (CCN) or Named data networking (NDN) have introduced a new networking model, where the communication is centered on named-data rather than host address. Indeed, in CCN every data packet is identified, addressed and retrieved by its unique name instead of its physical location. All network nodes potentially store the data that they forward to serve future requests for the same content. To this aim, it is possible to equip network nodes with enhanced storage capabilities such as caches/buffer memories. Indeed, storage resources can be used to maintain temporary content replicas spread through the network for a period of time ranging from minutes to hours or days. The availability of different replicas depends on several factors, such as content popularity, cache replacement policies, and is impacted by the request forwarding policy. The term “request forwarding policy” refers here broadly and as non-limitative, to ways/rules to manage the forwarding of a content request within a network comprising nodes. In fact, request forwarding policy plays an important role in providing better end-users performance (ex: data delivery time) and reducing the amount of data transferred in a network, i.e. providing a lower network load.

In CCN, content items/files are split in a sequence of chunks uniquely identified by a hierarchical name of possibly variable size B components, for instance the B components may be “/bell_labs/video/talks.avi/chunk1”. By considering the following example; the B-1 components identifies the content item name (/bell_labs/video/talks.avi); while the last component specifies the chunk name (chunk1). Servers in CCN announce the set of prefixes (here /bell_labs/video/ or /bell_labs/) of content items they can serve by means of routing protocols, i.e. prefixes of permanently stored items. Network nodes receiving these announcements build their forwarding/routing tables accordingly. For instance network nodes store in their routing tables, the shortest paths in terms of delay towards a permanent copy of a file. Chunks of a file are then requested by a receiver, through Interest packets that are forwarded by network nodes towards servers storing permanent copies of the requested chunks.

Interest packet here is a packet type, referring to interest/request about content item/file. Another packet type referred in this document is Data packet, corresponding to data transmitted in response to an interest/request of content (i.e. Interest packet). Indeed, a Data packet may be a chunk of a content item/file. Interest packet leaves traces that a matching chunk (i.e. Data packet) can follow via reverse path, to reach back the original requester. A matching chunk can be found in every node caching a temporary copy or at the server where the permanent copy is stored. In fact, one Interest packet permits to retrieve one Data packet. Hence, a sequence of Interest packets permits to retrieve a sequence of Data packets, i.e. for instance the chunks of a large piece of content such as a video file.

Miura H. et al: Content routing with network support using passive measurement in content distribution networks (XP 010610865) relates to content distribution networks in which user requests are directed to an adequate server from the view point of improvement of latency for obtaining contents. Round trip time passive measurement can improve user response time for both cases that network delay and server processing delay is dominant factor of response time.

EP 2 323 346 relates to adaptive multi-interface use for content networking. It is proposed a connectivity agent which can control the implemented policy by configuring strategy layer without having to process each individual packet. The connectivity agent can configure strategy layer with rules for choosing among multiple interfaces.

FIG. 1 shows the procedure upon reception of an Interest packet. When an Interest packet is received (step 101) by a node on an incoming interface the node checks for content availability in its Content Store (CS), such as a cache/buffer memory (step 102). If the content is available, the CS sends the requested Data packet back on the incoming interface (step 103). Otherwise, the node checks in its Pending interest Table (PIT) for a pending request, i.e. whether this content has been already requested upward over this interface (step 104). If an entry is found in the PIT, the PIT is updated (step 105) in order to track that the incoming interface is waiting for this content. If no PIT entry is found, a new entry is created and the Interest packet is forwarded to one or multiple interfaces determined via longest prefix match on the content name prefixes stored in a Forwarding table (step 106), referred in the background art as Forwarding Information Base (FIB). Moreover, the node can also probe interfaces not specified in the FIB (step 107) in order to discover other available routes and forward the Interest packet (step 108).

Now with referring to FIG. 2, the procedure upon reception of a Data packet is shown. When a Data packet is received by a node (step 201) the node checks for pending requests in its PIT (step 202). If a pending request is found, the Data packet is first stored in the node CS. The node updates its CS. PIT and FIB entries (respectively steps 203,204,205) and forwards the Data packet towards all requesting interfaces (step 206) as listed in the PIT. For example, when a Data packet is received; the node may update in its FIB information about the quality (for instance round-trip time (RTT), number of hops) of the interface from which the packet has been received. If no matching PIT entry is found, the Data packet is discarded (step 207).

Indeed, following the reception of an Interest packet, an ideal name-based routing protocol would have to address all temporary copies of every content item (i.e. Data packets), in order to forward user request towards the “best” (i.e. the closest in term of path/time in the network) available replica. Nevertheless, this is clearly unfeasible in CON, since:
in term of network scale, CCN may comprise content of different applications and is not intended to be confined to small, controlled network areas;
in term of time scale, temporary copies stored at network nodes are highly volatile and the signaling overhead involved by frequent route update would be excessive;
the nodes forwarding tables (i.e. the FIBs) size are already a matter of concern, even considering only permanent content copies rather than network-cached temporary replicas.

On the other hand, the usage of dynamic forwarding mechanisms, able to discover and exploit temporary content replicas can provide significant benefits in terms of end-user performance and network provider costs.

One idea to solve this problem would be to assume node FIB knowledge about multiple paths in a CON network, leading toward permanent copies that can be directly exploited by a forwarding strategy. However, it would require a routing protocol that distributes permanent copy availability information, and could not thus be applied to forward requests towards temporary copies.

One existing dynamic forwarding approach for Named-Data-Networking (NDN) framework relies on probing interfaces periodically, and gathering statistics for each of them. If for content, an interface is estimated to be better than the currently exploited one, the forwarding plane is switched to that interface. Although this proposition seems to be efficient, it is still needed to provide better performance in terms of end-user (ex; data throughputs) and to reduce network costs (ex: data load).

One object is to provide a solution to the aforementioned problems, and offers other advantages over the prior art.

Another object is to provide a mechanism to realize dynamic request forwarding in a CCN node.

Another object is to improve end-user performance.

Another object is to reduce network costs.

### SUMMARY OF THE INVENTION

Various embodiments are directed to addressing the effects of one or more of the problems set forth above. The following presents a simplified summary of embodiments in order to provide a basic understanding of some aspects of the various embodiments. This summary is not an exhaustive overview of these various embodiments. It is not intended to identify key of critical elements or to delineate the scope of these various embodiments. Its sole purpose is to present some concepts in a simplified form as a prelude to the more detailed description that is discussed later.

Various embodiments relate to a method for managing packets over interfaces of a Content Centric Networking node, the method comprising the following steps
receiving over an interface of the node at least a request for a data packet;
if the data packet is stored by the node, forwarding the data packet over the interface of the received request;

otherwise
performing an exploration step, by
   selecting randomly at least an interface towards a neighboring node;
   forwarding the request over the selected interface;
   receiving in response over the randomly selected interface, the data packet with associated minimum time delivery value estimated by the neighboring node;
identifying an interface providing the minimum data packet delivery time value based on exploration step results.

In accordance with a broad aspect, the method further comprises an exploitation step performed by
using the identified interface providing the minimum data packet delivery time, to forward the request and receive back the data packet;
receiving for the data packet, associated minimum time delivery value estimated over the identified interface.

In accordance with a broad aspect, the method requires standard ICN operations of storing the received data packet in a Content Store of the node and forwarding the received data packet over the interface used for receiving the request.

Further, various embodiments relate to a Content Centric Networking node for managing packets, the node being configured for
receiving over an interface of the node at least a request for a data packet;
forwarding the data packet over the interface of the received request if the data packet is stored by the node;

otherwise
selecting randomly at least an interface towards a neighboring node;
forwarding the request over the randomly selected interface;
receiving in response over the randomly selected interface, the data packet with associated minimum time delivery value estimated by the neighboring node;
identifying an interface providing the minimum data packet delivery time value based on exploration step results;
using the identified interface providing the minimum data packet delivery time, to forward the request and receive back the data packet;
receiving for the data packet, associated minimum time delivery value estimated over the identified interface;
storing in a Content store the received data packet and forwarding the received data packet over the interface used for receiving the request.

Various embodiments further relate to computer program products for performing the above method.

While the various embodiments are susceptible to various modification and alternative forms, specific embodiments thereof have been shown by way of example in the drawings. It should be understood, however, that the description herein of specific embodiments is not intended to limit the various embodiments to the particular forms disclosed.

It may of course be appreciated that in the development of any such actual embodiments, implementation-specific decisions should be made to achieve the developer's specific goal, such as compliance with system-related and business-related constraints. It will be appreciated that such a development effort might be time consuming but may nevertheless be a routine understanding for those or ordinary skill in the art having the benefit of this disclosure.

### DESCRIPTION OF THE DRAWING

The objects, advantages and other features of various embodiments will become more apparent from the following disclosure and claims. The following non-restrictive description of preferred embodiments is given for the purpose of exemplification only with reference to the accompanying drawing in which

FIG. 1 is a schematic diagram illustrating reception procedure of an Interest packet, according to the prior art;

FIG. 2 is a schematic diagram illustrating reception procedure of a Data packet, according to the prior art;

FIG. 3 is a schematic diagram illustrating transition phase of a dynamic interest forwarding mechanism, according to various embodiments;

FIG. 4 details the operations of a dynamic interest forwarding mechanism upon reception of an Interest packet, according to various embodiments;

FIG. 5 details the operations of a dynamic interest forwarding mechanism upon reception of a Data packet, according to various embodiments;

FIGS. 6 and 7 illustrate performance of a dynamic interest forwarding mechanism over the prior art, according to various embodiments.

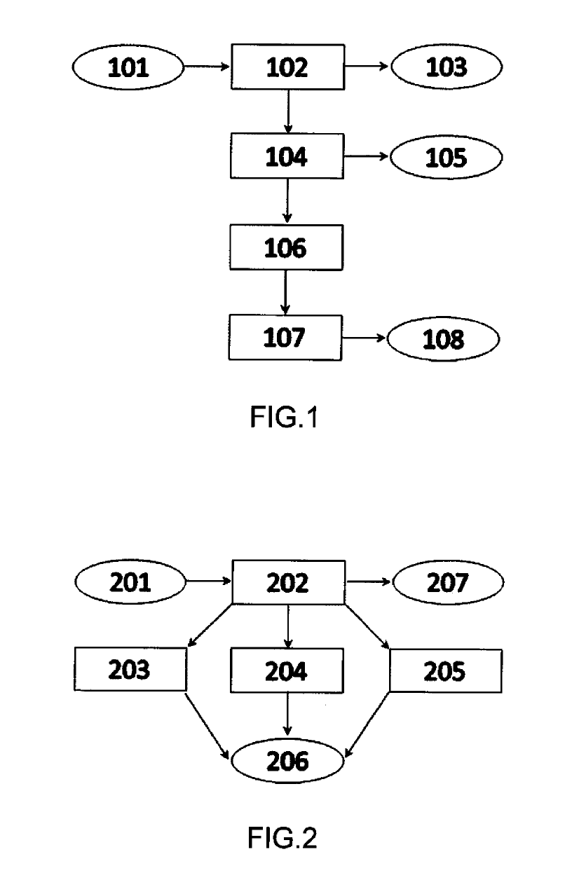

### DETAILED DESCRIPTION OF ILLUSTRATIVE EMBODIMENTS

In the following embodiments it is proposed to provide a dynamic request mechanism permitting
to discover paths to temporary copies of a content item that are not addressed in routing tables;
to forward requests for the content item towards the “best” performing interface (according to specified metric), while guaranteeing continuous Data delivery and limiting the network overhead.

In one embodiment, the dynamic request mechanism leverages a reinforcement learning approach for routing, and extends it to the case of a CON cached-network.

One known reinforcement learning approach in the prior art, is Q-routing. In a ( ) routing algorithm, each node of a network builds its routing table/FIB, by learning information, such as delivery times of a packet towards other nodes. These information are referred as Q values and are stored by every node i in their FIBs, for all possible destination nodes d, through each neighboring node v of node i. Qᵢ(d,v) is a Q value, representing the delivery time of a packet from node i to node d if the packet is forwarded via a neighboring node v among the neighboring nodes. In a Q-routing algorithm, the forwarding of a packet by a node i consists in selecting the interface to the neighboring node v, towards a given destination node d with the smallest Q value Qᵢ(d,v) i.e. the smallest delivery time. For every packet forwarded through a neighboring node v, the node i receives in response over the interface with node v, the “best” Q value of v that is the minimum delivery time estimated for node v i.e. minₖ_{_}ᵢₙ_{_}_{neighbours(v)}Qᵥ(d,k). The associated Q value at node i is then updated as follows:

Qᵢ(d,v)=(1−η)·Qᵢ(d,v)+η·(minₖ_{_}ᵢₙ_{_}_{neighbours(v)}Qᵥ(f,k)+rtt_{i,v}),

where η is a value referred as “learning rate”, f is a file referring to an Interest packet, rtt_{i,v} denotes the round trip delay between nodes i and v,

The term Q value is also referred to as a quality value or metric value and is associated with a respective metric. If the metric is a delivery time of time delay, for example an actual delivery time of a packet from a first node I to a second node d represents an actual Q value. The term “best” is referred to as a best value or best interface, both associated with a best value (minimum or maximum) of the associated metric.

In fact, Q-routing approach provides an effective way to improve performance with respective shortest path forwarding in presence of dynamic conditions, such as evolutions of links connection between nodes or storage capacities in network.

In a preferred embodiment, the reinforcement learning approach may be based on Q-routing, by implementing a distributed version of Q-learning. This distributed reinforcement learning, is performed at each network node in a CON network. In fact, a dynamic INterest FORrwarding Mechanism, further referred as INFORM is run by each node in the CCN network.

For at least a given file f/Data packet that can be requested by at least one Interest packet, a node i maintains in its FIB a set of Qᵢ(f, v) values, for v neighboring nodes in I(i) values, where I(i) denotes the set of interfaces of node i. These values are computed and updated during an exploration phase, where a node probes the interfaces in order to learn the cost/reward in terms of residual delay (rtt_{i,v}) to the first hitting cache for file f/Data Packet associated with each of them. As exposed above, an update step of Q values exploits the knowledge of the smallest Q value of a neighbor node v chosen for forwarding a given Interest packet, this value being piggy-backed in a returning Data packet. Q values are then used during an exploitation phase, to identify the best available interface where to forward Interest packets.

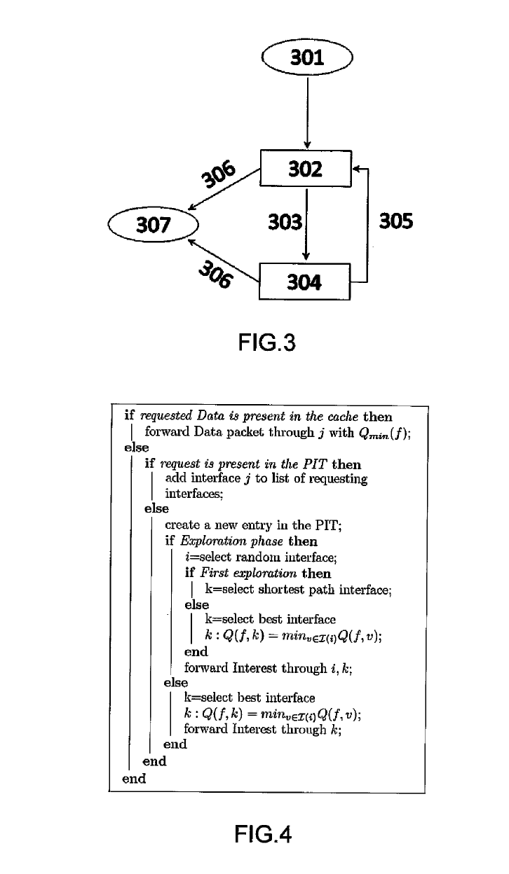

With reference to FIG. 3, the transitions phases of INFORM are detailed. The mechanism starts by initializing at node i the set of Q values Qᵢ(f, v) (step 301), for neighboring nodes v in I(i) values (set of interfaces of node i), when an Interest packet (i.e. a request) for a given Data packet/file f is received and corresponding Q values are not available in the node FIB. A first exploration phase then starts (step 302). The goal of such initial exploration phase, is to compute/update Q values for the different interfaces in I(i) values, while guaranteeing the delivery of the requested Data packets. To this end, a node i randomly select an interface in I(i) values to forward an incoming Interest packet, and at the same time, forwards the Interest packet over the interface providing the shortest path in terms of delay, towards a permanent copy of the file/Data packet. As a reminder, the shortest paths are stored too in the node FIB according to the content item servers announcements. Indeed, the use of permanent copy of the file permits to guarantee the delivery of Data packets during the exploration phase.

The exploration phase lasts Nr chunks (arrow 303), i.e. Nr Interest packets are sent by node i to randomly selected interfaces in I(i) values and Nr Data packets are forwarded back through these interfaces with best (i.e. minimum) delivery time values estimated. During this exploration phase Interest packets are also forwarded over the interface providing the shortest path in terms of delay towards a permanent copy of the file/Data packet. Then, Q values are updated, according to the Q value updating step formula mentioned above. After which the interface k providing the minimum delivery delay is identified, i.e.: Q (f, k)=minᵥ_{_}ᵢₙ_{_}_{I(i)}Q(f; v), and its Q value is stored, i.e. Qmin(f)=Q(f, k).

The best interface is one of a plurality of interfaces of a node, which is assigned to a metric and has the highest or lowest metric value according to the respective metric. Such a metric may be a delay from a first node to a second node of the CCN, a link cost or node cost, the number of hops or any other possible metric. So, for example, the best interface may be the interface which has the minimum value in a plurality of values determined by a shortest path algorithm towards a further node, the shortest path being discovered in a previous exploration phase.

After the exploration phase (step 302) the exploitation phase starts (step 304). The goal of this phase is to exploit the information (Q values) about cost/rewards delays associated with each interface collected during the exploration phase. To do so, an Interest packet is forwarded over the best interface k only, i.e. over the identified interface, providing the minimum time delivery value for a data packet. Data Packet is forwarded back over the same identified interface with the associated minimum time delivery value. Hence, during the exploitation phase the corresponding Q(f, k) value, referring to the identified interface delivery time, is the only one Q value still being updated. The mechanism remains in exploitation phase until
the reaching of a threshold value that is function of the Data packet delivery time value: |Qmin(f)−Q(f,k)|/Qmin(f)>δ, where δ is a threshold value. This event, indicates that system state has changed and that Q values need to be updated;
the duration of Nt chunks, i.e. until the reception of Nt Data packets at most. This event is also required because as, despite the Q value of the best interface is not significantly changed, the state of the other interfaces may have changed.

Consequently, after the exploitation phase (step 304), if one of this event occurs (arrow 305) the algorithm returns in exploration phase (step 302). As previously mentioned, this is required to deal with dynamic content availability, and to update Q values accordingly. Differently from the first exploration phase execution, during all the subsequent explorations an Interest packet (i.e. a request for a data packet) is forwarded towards a randomly selected interface, and, at the same time, towards the previously determined best interface k (rather than shortest path interface previously). At the end of this exploration phase (i.e. after Nr chunks), a new interface k′ providing the minimum delay is identified, i.e.: Q(f,k′)=minᵥ_{_}_{in I(i)}Q(f,v), the minimum Q value is updated, i.e. Qmin(f)=Q(f, k′), and the algorithm returns (arrow 303) in exploitation phase (step 304).

Finally, Q values associated with a given file f/Data packet are deleted (step 307) when they are not updated for Te time units (arrows 306), i.e. no Interest packet for file f/Data Packet is forwarded by the node during a time period Te. This situation may occur indifferently during the exploration or the exploitation phase.

FIG. 4 details the operations performed by INFORM upon reception by a node i in a CCN network, of an Interest packet for a Data packet, forwarded from an interface i. If the requested Data packet is present in the CS (for example a buffer memory) of the node, then it is send over the interface that requested it. The minimum value Qmin(f) is also added to the Data packet, as it will be used by downstream nodes to update their Q values. Otherwise if a pending request for the Data packet is not present in the node PIT, and INFORM is in exploration phase, the Interest packet is forwarded over a random interface, and over the best interface (or over the interface towards the shortest path in terms of delay in case of first exploration). Alternatively, if the algorithm is in exploitation phase, the Interest packet is forwarded towards the best interface k only,

According to an embodiment the method for operating a Content Centric Networking node comprises the exploration phase 302, the exploration phase 302 comprising the steps of: receiving a first request for a data packet: determining that the data packet requested with the first request is not stored by the node, forwarding the first request over a first interface i, if the data packet requested with the first request is not stored by the node, and forwarding the first request over a second interface k, if the data packet requested with the first request is not stored by the node.

According to an embodiment the first interface i is selected out of the plurality of interfaces according to a random selection scheme, wherein the second interface k is selected out of the plurality of interfaces according to a first metric dependent selection scheme.

According to an embodiment the random selection scheme comprises determining the first interface i according to a uniform distribution over the plurality of interfaces.

According to an embodiment the random selection scheme comprises: assigning a probability to each of the plurality of interfaces proportional to a metric value Q assigned to the respective interface; and determining the first interface j out of the plurality of interfaces according to the assigned probabilities.

According to an embodiment the metric dependent selection scheme comprises: determining the second interface k according to a shortest path algorithm, wherein the shortest path algorithm is executed beforehand on the basis of a delay to a file f in the Content Centric Network.

According to an embodiment an exploitation phase 304 is executed after the exploration phase 302, wherein the exploitation phase 304 comprises: receiving a second request for the data packet; and determining that the data packet requested with the second request is not stored by the node;

According to an embodiment the method comprises: forwarding the request only over a third interface, if the data packet requested with the second request is not stored by the node.

According to an embodiment the third interface is selected out of the plurality of interfaces according to a second metric dependent selection scheme.

According to an embodiment the exploitation phase 304 ends and the exploration phase 302 starts when a minimum time delivery values for a data packet reaches a threshold value, wherein the exploration step 302 ends and the exploitation step 304 starts when a predefined number of data packets is received.

According to an embodiment the node maintains a metric value Q for each of the plurality of interfaces and for each file f in the Content Centric Network, wherein the metric value Q represents a delay to a file f residing in the Content Centric Network.

According to an embodiment in response to the first and/or second and/or third request over the first interface and/or the second interface and/or the third interface a data packet and the metric value Q associated with the data packet, especially a minimum time delivery value for the data packet from its origin to a neighboring node estimated by a neighboring node, is received, and wherein the metric value Q is stored.

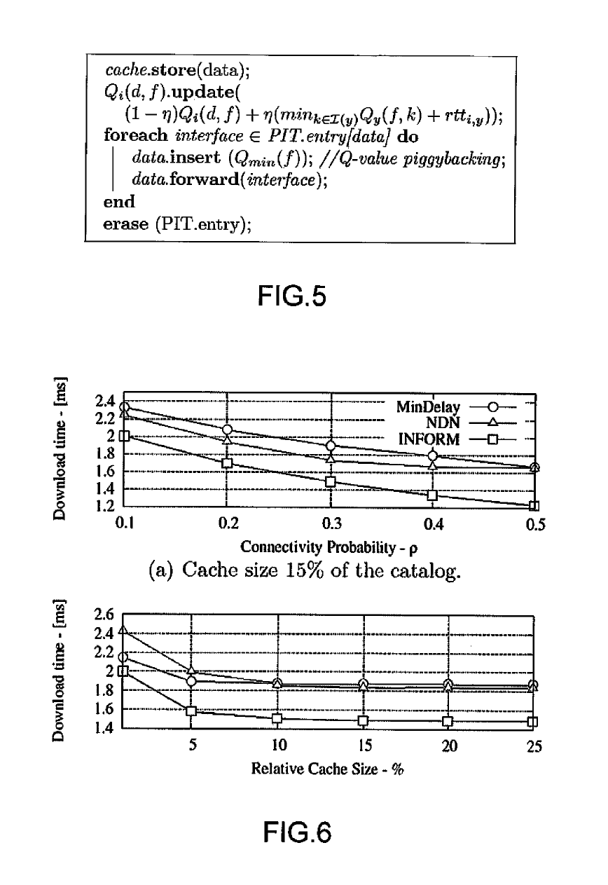

According to an embodiment the metric values Q of the first or second request are compared and a best metric value Q in form of a minimum or maximum value is determined according to the respective metric, and wherein the second and/or third interface k is selected according to the best metric value Q associated with the respective interface. FIG. 5 shows operations performed by INFORM upon reception by a node in a CCN network, of a Data packet on interface′ from a neighbor node y. After storing the received Data packet in its CS (such as cache), the Q value associated with the incoming interface of the considered file f is updated. Finally, the list of requesting interfaces of the Data Packet, is looked up from the PIT of node i, and the Data packet is forwarded towards the interested interfaces then the PIT entry is finally removed.

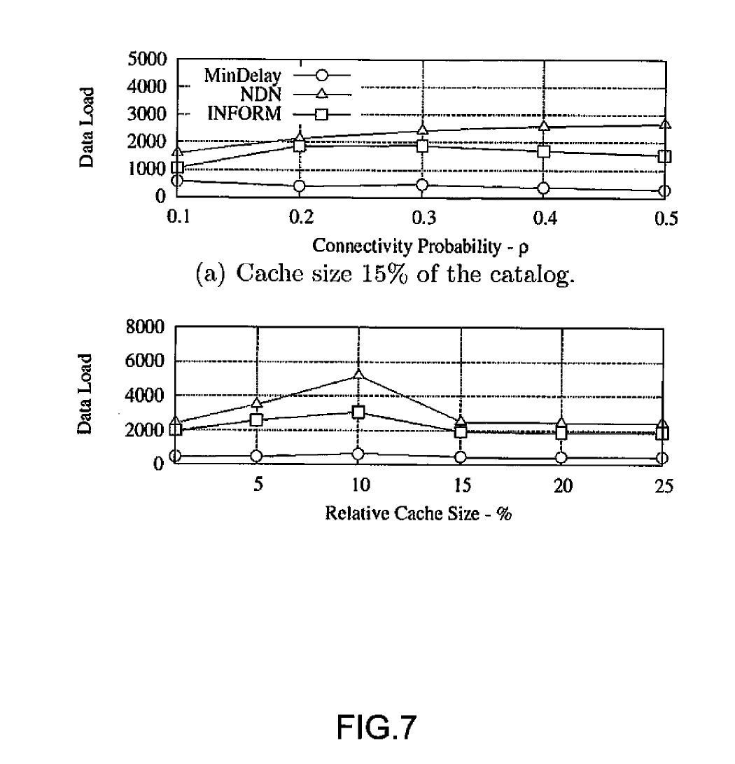

As illustration of the achievable performance with the disclosed mechanism, FIGS. 6 and 7 report the results obtained by means of packet-level simulation under several scenarios.

In all scenarios, a network topology is modeled as an Erdos-Renyi graph G(n, p) where n is the number of nodes and ρ is the probability that a link connecting two nodes does exist. We assume b is a number of border routers among the n nodes where users are connected to, and s<=n is the number of content servers connected to the network.

It is assumed herein that n=22, b=8, s=1, and p=0.3. It is further assumed that every node is equipped with a cache of size c=15% of a content catalog and implements a Least Recently Used (LRU) replacement policy. The placement of border routers and servers are randomly generated, results are averaged over multiple simulation runs, and cache warm up period is not considered. Users generate content requests according to a Poisson process of intensity λ=1 request per second per border router. A catalog of 10̂5 content items (i.e. files) is chosen, whose popularity is a Zipf distribution with u=1. It is assumed too, that each content item is composed of 100 independent Data packets that are permanently stored at content servers s. Finally, the FIBs of the nodes are configured with next hop information for the minimum delay path towards one of the permanent content item copy.

On FIGS. 6 and 7, INFORM is compared with min-delay path forwarding and a NDN forwarding scheme supposed to be currently one of the best available existing solutions.

To do so, two metrics are considered herein:
the Data packet delivery time, which represents the time elapsing between a client expression of a Interest for a given packet, and the reception of the corresponding Data packet;
the Data load, defined as the average number of Data packets owing through the network in one time unit.

Moreover, the learning rate is set to η=0.7, the duration of the exploration phase to Nr=50 chunks, and the duration of the exploitation phase to Nt=100 chunks.

Curve (a) of FIG. 6, reports the average Data packet delivery time as a function of the network connectivity (i.e. probability ρ that any two nodes are connected), which determines the number of available paths between clients and servers. It is clearly observed, that the delivery time decreases as the network connectivity increases. As the number of links in the network increases, the distance between clients and servers is reduced, with a consequence decrease in the delivery time. INFORM provides the smallest delivery time among the three mechanisms for all connectivity values. Specifically, it provides a performance improvement between 18-33% with respect to simple min-delay path forwarding, and between 10-33% with respect to the NDN forwarding strategy. The performance gap increases with the connectivity, testifying that INFORM can better exploit an increasing number of paths.

Curve (b) of FIG. 6, shows the average Data packet delivery time as a function of the cache size. It is observed that the delivery time sharply decreases as the cache size increases (until additional storage does not provide any additional benefits). Moreover INFORM outperforms other algorithms for all cache sizes providing an improvement of 22-25% with respect to the NDN forwarding strategy and 5-26% with respect to min-delay path forwarding.

Curves (a) and (b) of FIG. 7, report the Data load as a function of the network connectivity and cache size respectively. It is observed that INFORM generates less traffic than the NDN forwarding scheme, but clearly more than min-delay path forwarding. As the network connectivity or cache size increase, the Data load decreases for min-delay path forwarding. Differently, for INFORM and NDN, the Data load first increases and then decreases as the connectivity and cache size increase. Additional links in the network or storage capacity increase the availability of temporary item replicas that are discovered by such algorithms: it follows requests are forwarded through longer paths to reach those replicas resulting in a higher Data Load. After a certain threshold, the load decreases as more links or additional storage capacity do not increase item availability but only shorten the distance between clients and item copies thus reducing the load on the network.

Advantageously, the above described embodiments permit to provide a dynamic request forwarding mechanism that clearly outperforms current existing solutions in terms of end-user performance (i.e. delivery time) and network costs (reductions of the load in the network).

Advantageously, the disclosed embodiments make feasible the implementation of dynamic forwarding algorithms in CCN nodes, and more generally within high-speed network equipments in order to provide the best performance.

1.-15. (canceled)

16. A method for managing packets over interfaces of a Content Centric Networking node, the method comprising:
receiving over a first interface of the node at least a request for a data packet;
if the data packet is stored by the node, forwarding the data packet over the first interface of the received request; otherwise
performing an exploration step, by
selecting randomly a second interface out of a set of interfaces of the node towards a neighboring node;
forwarding the request over the second interface;
receiving in response over the second interface—the data packet with associated time delivery value towards a copy of the packet estimated by the neighboring node;
selecting a third interface out of a set of interfaces of the node towards a neighboring node, the third interface being a best interface;
forwarding the request over the third interface;
receiving in response over the third interface the data packet with associated time delivery value towards a copy of the packet estimated by the neighboring node;
identifying an interface providing the minimum data packet delivery time value based on exploration step results.

17. The method according to claim 16, further comprising an exploitation step performed by
using the identified interface providing the minimum data packet delivery time, to forward the request and receive back the data packet;
receiving for the data packet, associated minimum time delivery value estimated over the identified interface.

18. The method according to claim 16, wherein during the exploration step, if an interface providing the minimum time delivery value is not yet identified, forwarding the request at the same time as the randomly selected interface over an interface towards a permanent copy of the data packet.

19. The method according to claim 16, wherein during the exploration step, if an interface providing the minimum time delivery value is identified, forwarding the request at the same time as the randomly selected interface over the identified interface.

20. The method according to claim 17, wherein the exploration step is performed until a first event, the first event being the reception of a predefined number of data packets.

21. The method, according to claim 20, wherein the exploitation step is performed following the said first event.

22. The method according to claim 21, wherein the exploitation step is performed until a second event, the second event being the reaching of a threshold value that is function of minimum time delivery value estimated.

23. The method according to claim 21, wherein the exploitation step is performed until a third event, the third event being the reception of a predefined number of data packets at most.

24. The method according to claim 23, wherein the exploration step is performed following the second event or the third event.

25. The method according to claim 16, wherein information referring to delivery time values is stored in a Forwarding Information Base of the node.

26. The method according to claim 25, wherein the said information are deleted from the Forwarding Information Base of the node when no request for data packet is forwarded by the node during a predefined time period.

27. The method according to claim 25, wherein the said information is initialized when a request for a data packet is received and the information are not available in the Forwarding Information Base of the node.

28. The method according to claim 16, further comprising a storing step of received data packet in a Content Store of the node and a forwarding step of the received data packet over the interface used for receiving the request.

29. A Content Centric Networking node for managing packets over interfaces of the Content Centric Networking Node, the node being configured for
receiving over a first interface of the node at least a request for a data packet;
forwarding the data packet over the first interface of the received request if the data packet is stored by the node; otherwise
performing an exploration step, by
selecting randomly a second interface out of a set of interfaces of the node towards a neighboring node;
forwarding the request over the second interface;
receiving in response over the second interface the data packet with associated time delivery value towards a copy of the packet estimated by the neighboring node;
selecting a third interface out of a set of interfaces of the node towards a neighboring node,
the third interface being a best interface;
forwarding the request over the third interface;
receiving in response over the third interface the data packet with associated time delivery value towards a copy of the packet estimated by the neighboring node;
identifying an interface providing the minimum data packet delivery time value based on exploration step results.

30. A Content Centric Networking node configured to execute the method according to claim 16.

31. A computer readable medium storing computer readable instructions which when executed by a computer cause the computer to perform the method of claim 16.
